(19) United States
(12) Patent Application Publication
(10) Pub. No.: US 2025/0011233 A1
(43) Pub. Date: Jan. 9, 2025

(54) CONVEYING DEVICE FOR A PLANT FOR THE PRODUCTION OF CEMENT

(71) Applicant: KHD HUMBOLDT WEDAG GmbH, COLOGNE (DE)

(72) Inventor: Matthias MERSMANN, STOLBERG (DE)

(21) Appl. No.: 18/709,407

(22) PCT Filed: Nov. 11, 2022
(86) PCT No.: PCT/EP2022/081629

§ 371 Date: May 10, 2024

(30) Foreign Application Priority Data
Nov. 11, 2021 (DE) 10 2021 129 323.5

(51) Int. Cl. C04B 7/44; C04B 7/36

(52) U.S. Cl. CPC C04B 7/4415; C04B 7/362

(57) ABSTRACT

A conveying device for conveying bulk material for a plant for producing cement clinker, wherein the plant for producing cement clinker operates in the recirculation process and/or in the oxy-fuel process, and wherein the conveying device has a connection to the plant, in which the bulk material to be transported passes into the plant. The connection between the conveying device and the plant for producing cement clinker has a gas supply for pressurizing the connection with recirculation gas. Also a method.

### CROSS-REFERENCES TO RELATED APPLICATIONS

This application is a national phase of International Patent Application No. PCT/EP2022/081629, filed on Nov. 11, 2022, which claims the benefit of German Patent Application No. 10 2021 129 323.5, filed on Nov. 11, 2021, the entire disclosures of which are incorporated herein by way of reference.

### FIELD OF THE INVENTION

The invention relates to a conveying device for conveying bulk material for a plant for the production of cement clinker, wherein the plant for the production of cement clinker operates in the recirculation process and/or in the oxy-fuel process, and wherein the conveying device has a connection with the plant for the production of cement clinker, in which bulk material to be transported passes into the plant for the production of cement clinker.

### BACKGROUND OF THE INVENTION

To produce cement clinker, calcareous rock is first ground together with siliceous rock into raw meal and then subjected to heat treatment in an entrained flow reactor in an atmosphere of nitrogen-rich combustion air in a cement clinker production plant. During the heat treatment, carbon dioxide (CO₂) is formally driven out of the calcareous rock from the carbonate (CO₃²⁻) contained in the lime. This heat treatment produces carbon dioxide (CO₂) from two sources, namely from the combustion of fuels, whether renewable or fossil, and from the expulsion of carbon dioxide (CO₂) from the lime (CaCO₃). In order to reduce carbon dioxide emissions into the atmosphere, the first plants are now operated nitrogen-free or at least with a low nitrogen content and carbon dioxide (CO₂) is used as the carrier gas. This changes the solid matter chemistry and the heat balance of this plant. The aim of nitrogen-free or low-nitrogen, but high-carbon dioxide production of cement clinker is to inject the carbon dioxide (CO₂) into underground caverns. The low nitrogen content of the carbon dioxide-rich waste gas to be injected saves considerable compression work.

To provide an exhaust gas enriched with as much carbon dioxide (CO₂) as possible from a plant for the production of cement clinker, this can be operated in a so-called oxyfuel process. The carbon dioxide-enriched waste gas from this plant is largely recirculated and enriched with the oxygen (O₂) required for the combustion processes. The aim is to produce a gas mixture consisting as exclusively as possible of carbon dioxide (CO₂) and water vapor (H₂O), and in particular to minimize nitrogen (N₂), which is considered a contaminant. In this sense, the ingress of atmospheric air from the environment into the system operated under negative pressure is harmful. The usual proportion of false air in the flue gas of a clinker kiln line downstream of the heat exchanger is between 15% in a properly installed new system and up to 30% in an old system. A not inconsiderable proportion of the atmospheric air enters the kiln system via the flour feed, as on the one hand the transport and dosing devices used there can only be incompletely sealed against the atmospheric ambient air and on the other hand there is also a high proportion of pore volume within the fine bulk material flow that is filled with atmospheric air.

The invention is therefore based on the task of preventing the ingress of false air through the raw meal feed.

### SUMMARY OF THE INVENTION

The problem according to the invention may be solved by a conveying device with the features according to one or more embodiments described herein. Additionally, a method for operating a system comprising such a conveying device and the use of recirculation gas for operating a pneumatic conveying device is further disclosed.

According to the idea of the invention, it is provided that the conveying device has a further connection to the plant for producing cement clinker, a gas supply for pressurizing with recirculation gas. This gas supply displaces any atmospheric air during the transfer of the bulk material to be conveyed during the transfer to the plant for the production of cement clinker.

In order to control the quantity of the conveyed bulk material, it can be provided that the conveying device has a control device which adjusts the quantity of the gas supply depending on the flow speed of the pneumatically conveyed bulk material, whereby the gas supply increases with a lower flow speed of the pneumatically conveyed bulk material and decreases with a higher speed of the pneumatically conveyed bulk material.

### BRIEF DESCRIPTION OF THE DRAWINGS

The invention is explained in more detail with reference to the following

### FIGURES

It shows:

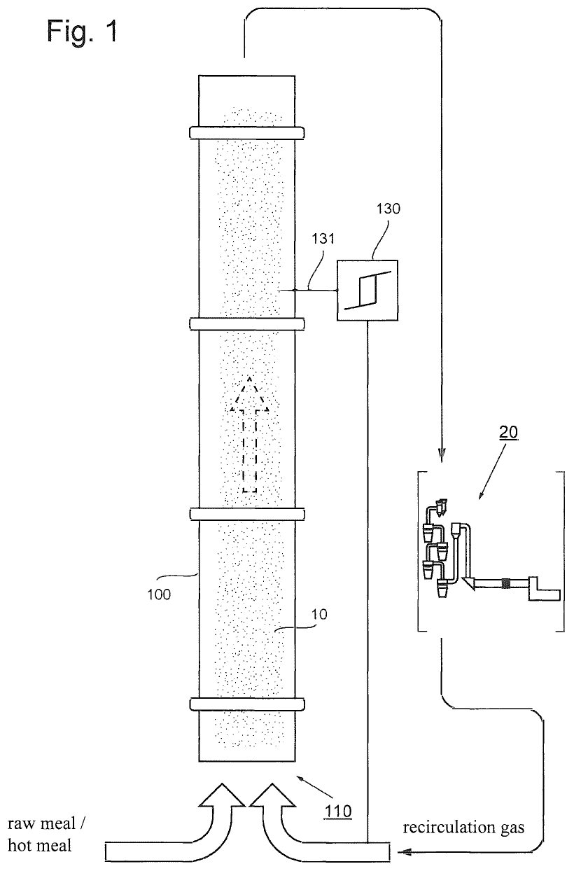

FIG. 1 a first embodiment of the conveying device according to the invention.

### DETAILED DESCRIPTION OF THE PREFERRED EMBODIMENTS

FIG. 1 shows a sketch of an embodiment of the conveying device according to the invention. This embodiment of the conveying device 100 is a pneumatic lifting device which conveys bulk material 10 vertically or at least with a vertical component upwards with the aid of a gas flow of recirculation gas. Instead of atmospheric air, recirculation gas is fed into the lower area as connection 110 of the pneumatic lifting device as conveying device 100 with the plant 20 for the production of cement clinker. A control device 130 can detect the flow velocity in the pneumatic lifting device via a sensor 131 and regulate the gas supply depending on this. The flow velocity decreases as the bulk material to be transported is fed in. If the flow velocity drops in the pneumatic lifting device, more gas must be fed into the pneumatic conveying device for pneumatic conveying in order to maintain the flow velocity. If, on the other hand, the flow velocity increases, this indicates that less bulk material is being lifted. To reduce the flow velocity again, less gas can therefore be fed into the pneumatic lifting device.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

10 Bulk material
20 Plant
100 Conveying device
110 Connection
120 Gas supply
130 Control device
131 Sensor
220 Gas supply

1.-5. (canceled)

6. A device for conveying bulk material for a plant for production of cement clinker, wherein the plant operates in a recirculation process, or in an oxy-fuel process, or both, in the device comprising:
a first connection with the plant, in which bulk material to be transported passes into the plant, and,
a further connection to the plant configured to provide a gas supply for pressurizing with a recirculation gas.

7. The device according to claim 6, wherein the device is a pneumatic lifting device.

8. The device according to claim 6, further comprising:
a control device configured to adjust an amount of gas supply as a function of a flow rate of a pneumatically conveyed bulk material,
wherein the gas supply increases with a lower flow velocity of the pneumatically conveyed bulk material and decreases with a higher velocity of the pneumatically conveyed bulk material.

9. A method for operating a plant for producing cement clinker, wherein the plant operates in a recirculation process, or in an oxy-fuel process, or both, and wherein the plant comprises at least one pneumatic conveying device for conveying bulk material, the method comprising:
pressurizing the at least one pneumatic conveying device with a recirculation gas.
